(19) United States
(12) Patent Application Publication
(10) Pub. No.: US 2017/0120742 A1
(43) Pub. Date: May 4, 2017

(54) RADIATOR MOUNT FOR VEHICLES

(71) Applicants: Kevin S. McCardle, Philadelphia, PA (US); John Petty, Philadelphia, PA (US)

(72) Inventors: Kevin S. McCardle, Philadelphia, PA (US); John Petty, Philadelphia, PA (US)

(73) Assignee: RESOURCE INTERNATIONAL, INC.

(21) Appl. No.: 15/337,664

(22) Filed: Oct. 28, 2016

Related U.S. Application Data
(60) Provisional application No. 62/250,251, filed on Nov. 3, 2015.

(51) Int. Cl. B60K 11/04

(52) U.S. Cl. CPC B60K 11/04

(57) ABSTRACT

A radiator assembly having a support bar, mounting pegs, and a radiator. The support bar has a center portion and respective end portions welded to the center portion. The end portions have respective flared ends that mate with the center portion and a pair of support mounts. The mounting pegs mate have a flexible portion that mates with the support mounts and a comolded fastener that mates with the radiator.

### RELATED APPLICATIONS

This application claims priority from U.S. Provisional Patent Application Ser. No. 62/250,251 which was filed on Nov. 3, 2015.

### FIELD OF THE INVENTION

The present invention generally relates to vehicles. More particularly, it relates to a support bar for heat exchangers including oil coolers and radiators.

### BACKGROUND OF THE INVENTION

In many front part body structures of vehicles, an engine compartment is generally provided in front of a cabin. A front part of the vehicle shown in FIG. 1 contains the engine compartment and is provided with front side members 2, 4 positioned at right and left sides in a lateral direction of the vehicle, a plurality of cross members 6, 8 that bridge the side members, suspension support elements 12, 14 attached to the front side members, and upper frame members 16, 18 fixed at one end at the cabin side, the other ends of the upper frame members are fixed to respective front pillars members 20, 22. Front suspension elements are respectively fixed to the right and left suspension support elements. The upper frame members 16, 18 positioned at the right and left sides in the lateral direction of the vehicle are extended in a longitudinal direction of the vehicle and formed a closed sectional structure. The upper frame members 16, 18 are joined opposite cabin side by upper cross member 10. Respective outer body panels are mounted to the various members. The respective members are joined by bolts or welds, typically arc welds.

A radiator 100 for an automotive engine cooling system is affixed to the front pillar members 20, 22, cross member 6 and the upper member 10. The radiator 100 typically includes a top tank, bottom tank, and a core. Alternatively, the radiator can be constructed with left and right tanks for cross-flow. Resilient mounts may be used because the radiator may be subject to vibrations, high forces, and shocks during normal use due to jolts, accelerations, or decelerations of the vehicle as it is driven over rugged terrain. Although the frame formed by the various members is advantageous in that rigidity can be obtained, the upper frame bears a load from the front suspension of the vehicle. This load is transferred to the radiator 100. This load, which may be transferred as torque, can damage the radiator 100.

### SUMMARY OF THE INVENTION

A radiator mounting arrangement on a vehicle includes a frame member having a center assembly, left and right end caps, and radiator mounting brackets. The radiator has respective mounts that mate with the mounting brackets. The radiator mounting arrangement is inexpensive, requires few parts and is fast and easy to assemble and does not transfer damaging forces to the radiator.

A radiator assembly comprises a radiator and a support bar. The support bar is configured to be attached to a vehicle by respective end caps and brackets. The support bar, end caps, and brackets are produced from die cast steel components, steel plate, and steel tubing. Each of the pieces is about 0.05-2 inches (1.7-5 mm) thick. The entire support bar, end caps and brackets are fully welded to minimize flex and torque transfer from the vehicle to the radiator. The radiator is mounted to the support bar using pegs. The pegs have a threaded bolt portion that is co-molded with a flexible material such as rubber, or the like. The peg threads into the radiator and is secured to the support bar by a retaining clamp. The support pegs further minimize flex and torque transfer from the vehicle to the radiator.

The radiator assembly comprises a support bar comprising, a center portion and respective end portions welded to the center portion, wherein the end portions having respective flared ends that mate with the center portion; and a pair of support mounts; at least two pegs con figured to mate with the support mounts, the pegs having a rubber portion that mates with the support mounts and a comolded bolt; and a radiator having receiving mounts configured to receive the comolded bolt of the peg.

According to one embodiment, the center portion is a rectangular tube.

According to one embodiment, the rectangular tube is substantially 0.07 inches (2 mm) thick.

According to one embodiment, the respective end portions are cast steel.

According to one embodiment, the respective end portions mate with the center portion with about 0.03 inches (1 mm) of clearance.

### BRIEF DESCRIPTION OF THE DRAWINGS

FIG. 1 is a perspective view of a front part of the vehicle containing;

FIG. 2 is a perspective view of a radiator support bar;

FIG. 3 is a front view of the radiator support bar;

FIG. 4 is a top view of the radiator support bar;

FIG. 5 is a perspective view of a center assembly of the radiator support bar;

FIG. 6 is a front view of a center assembly of the radiator support bar;

FIG. 7 is an end view of a center assembly of the radiator support bar;

FIG. 8 is a blank for a notch in the center assembly of the radiator support bar;

FIG. 9 is a perspective view of the formed notch in the center assembly of the radiator support bar;

FIG. 10 is a tab for the center assembly of the radiator support bar;

FIG. 11 is a left end cap for the radiator support bar;

FIG. 12 is a right end cap for the radiator support bar;

FIG. 13 is a bracket for the radiator;

FIG. 14 is the radiator mounted to a support bar;

FIG. 15 is the radiator and mounting peg;

FIG. 16 is the mounting peg attached to the radiator

FIG. 17 is the mounting peg; and

FIG. 18 is a cross section of the mounting peg; and

FIG. 19 is a cross section of the mounting peg.

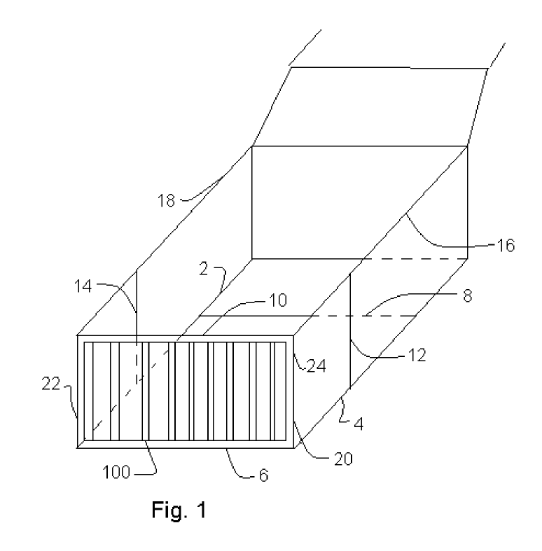

### DESCRIPTION OF THE PREFERRED EMBODIMENT

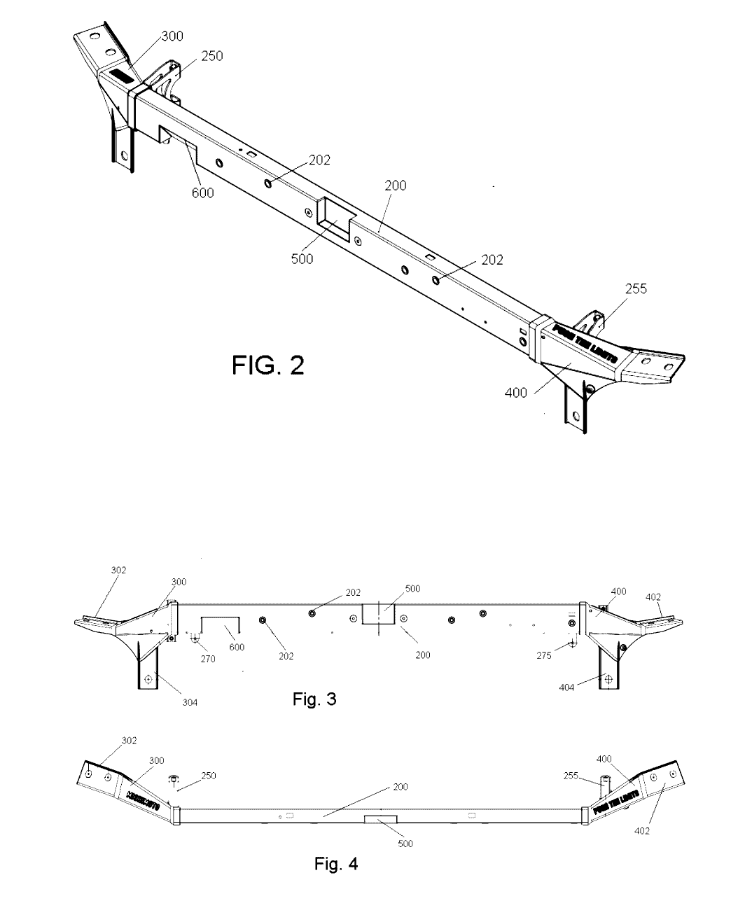

FIG. 2 is a perspective view of a radiator support bar. The radiator support bar comprises a center assembly 200, a left end cap 300, and a right end cap 400. The left end cap 300 and right end cap 400 are attached to the center assembly 200 by welding, bolts, or the like. Also shown in FIG. 2 brackets 250 and 255 are affixed to the left end cap 300 and the right end cap 400. Given a specific application for the support bar, notches 500, 600 may be present that accommodate hood latches, cables, and the like.

In one embodiment, the support bar has an anti-corrosive finish, is powder coated, plated, or the like. Alternatively, the support bar is painted. The threads of nuts 202 are preferably protected during any finishing process. By protecting the threads, the threads are able to receive a bolt.

FIG. 3 is a front view of the radiator support bar and FIG. 4 is a top view of the radiator support bar. In the front view of the support bar, mounting tabs 270, 275 are shown. Mounting tabs 270, 275 are welded to center assembly 200. The left end cap 300 includes mounting ear 302 that extends substantially longitudinally with respect to the center assembly 200. Another mounting ear 304 extends substantially perpendicular with respect to center assembly 200. The right end cap 400 includes mounting ear 402 that extends substantially longitudinally with respect to the center assembly 200. Another mounting ear 404 extends substantially perpendicular with respect to center assembly 200.

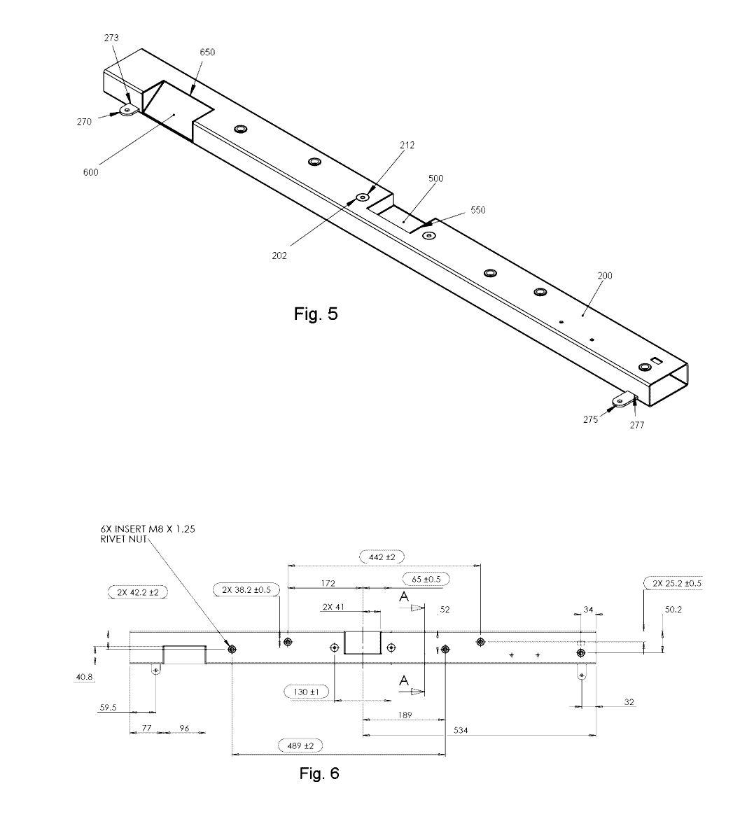

FIG. 5 is a perspective view of a center assembly of the center assembly 200. As shown, there is a weld fillet 550 for the weld that attaches the notch 500 to the center assembly 200. A weld fillet 650 attaches the notch 600 to the center assembly 200. A weld fillet 273 attaches the mounting tab 270 to the center assembly 200. A weld fillet 277 attaches the mounting tab 275 to the center assembly 200. A weld fillet 212 attaches the nut 202 to the center assembly 200. In one embodiment, the welds are ground smooth as part of the assembly process.

FIG. 6 is a front view of the center assembly 200 of the radiator support bar. FIG. 6 shows the center assembly 200 with dimension lines for a specific application. As one skilled in the art would readily appreciate, these dimensions can be adjusted for specific vehicles as required. The placement of the nuts 202 and notches can be adjusted as required for different applications. Further, the mounting tabs 270, 275 can be adjusted as required.

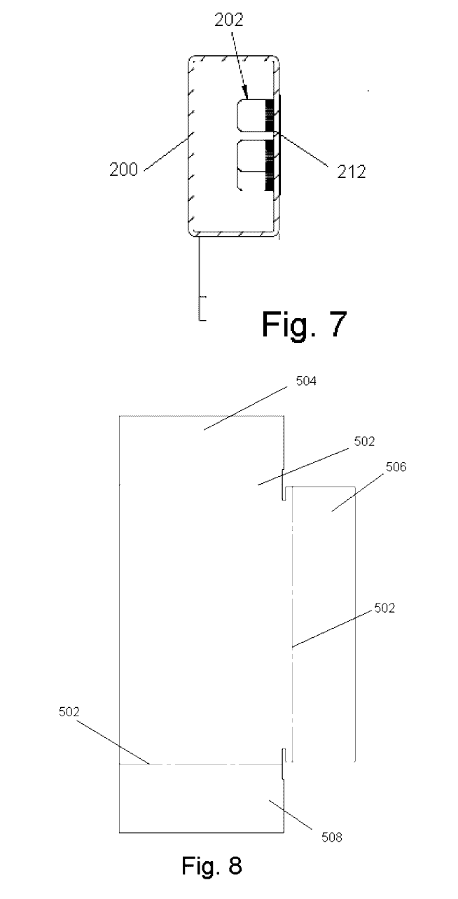

FIG. 7 is an end view of the center assembly 200 of the radiator support bar. As shown, the nuts 202 are welded by weld 212 to the center assembly 200. The nuts 202 are arranged inside the rectangular tube that forms the center assembly 200. In one embodiment, the nuts 202 are self-clinching fasteners. The self-clinching fasteners install permanently in metal sheets by pressing them into properly sized holes. This forces displaced sheet material to cold flow into an annular recess in the shank or pilot of the fastener, locking it in place. A serrated clinching ring, knurl, ribs, or hex head prevents the fastener from rotating in the metal when technicians apply tightening torque to the mating hardware. The fasteners can be installed during fabrication or final assembly.

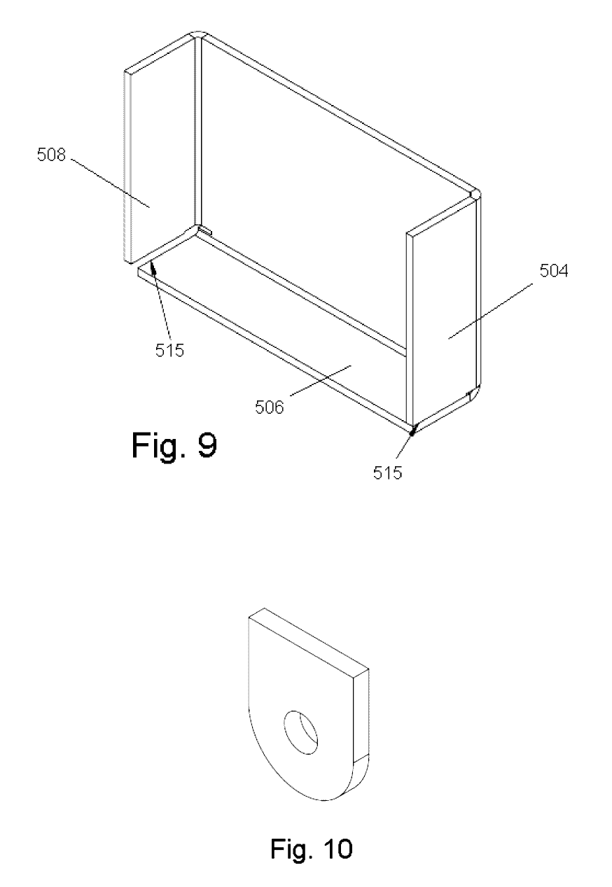

FIGS. 8 and 9 are an example of the notch 500. FIG. 8 is a blank used to form the notch 500. Edge portions 504, 406, and 508 are folded at substantially 90 degrees on fold lines 502. As shown in FIG. 9, the seam 515 at which edge portions 504 and 506 meet is welded and the seam 515 at which edge portions 506 and 508 meet is welded. This assembly is then welded into the center assembly 200. In another embodiment, the blank has tabs that can be attached to the center assembly 200 by screws, nuts and bolts, and the like.

FIG. 10 is an example of mounting tabs 270 and 275. The tabs are typically made from 0.1 inches (3 mm) thick mild steel plate. The tabs are dimensioned as required for mounting in a given application. The mounting tabs 270 and 275 are dimensioned as required for various mounting configurations.

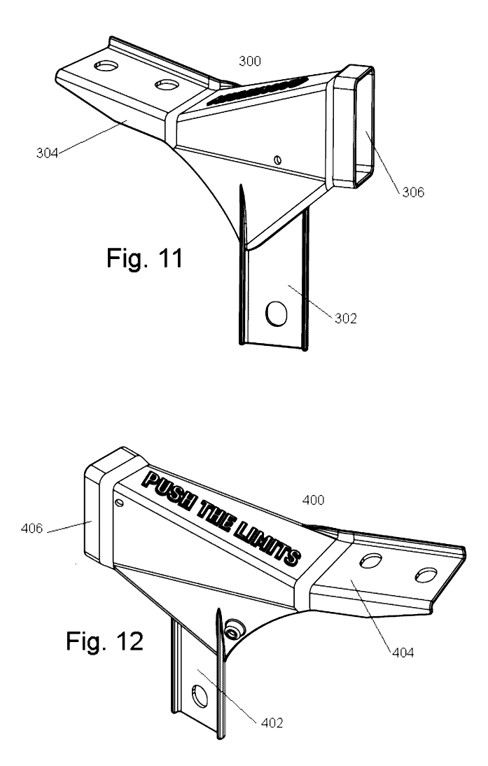

FIG. 11 is an example of the left end cap 300 for the radiator support bar. The left end cap 300 is cast mild steel. After casting, the part is finished by sandblasting. The left end cap 300 has a mating portion 306 that mates with the center assembly 200. The mating portion 306 is configured to mate with the center assembly 200 so that it can be welded. The mounting ears 302, 304 are configured to mount with the frame members that form the engine cabin of the vehicle.

FIG. 12 is an example of the right end cap 400 for the radiator support bar. The right end cap 400 is cast mild steel. After casting, the second part is finished by sandblasting. The right end cap 400 has a mating portion 406 that mates with the center assembly 200. The mating portion 406 is configured to mate with the center assembly 200 so that it can be welded. The mounting ears 402, 404 are configured to mount with the frame members that form the engine cabin of the vehicle.

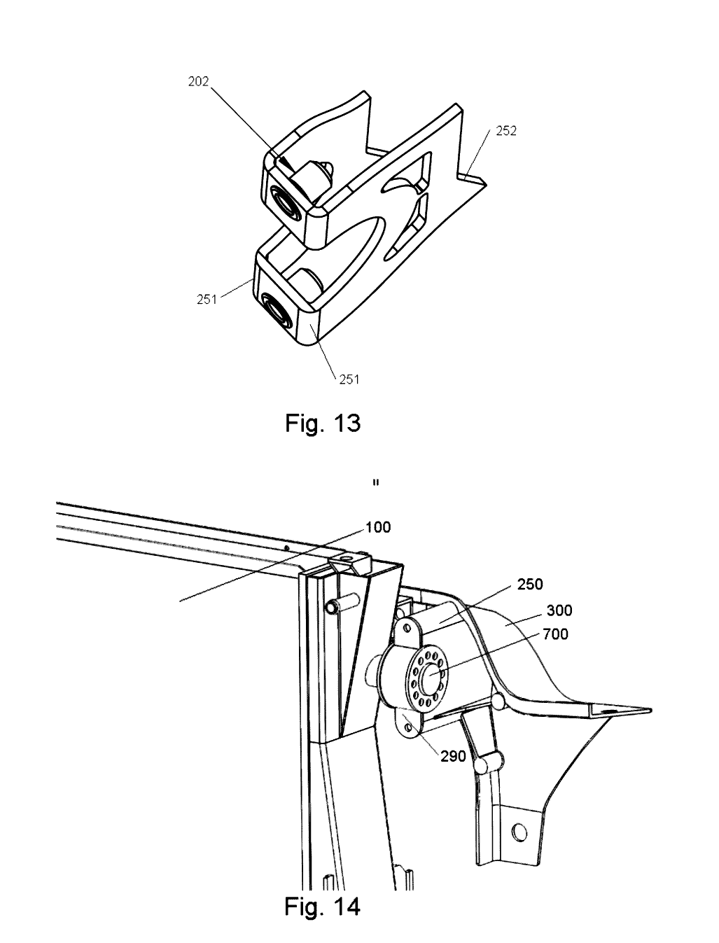

FIG. 13 is an example of the brackets 250, 255. Typically, the brackets 250, 255 are made from flat mild steel plate. The piece of steel is appropriately punched and folded at fold lines 251. Nuts 202 are welded into the brackets 250, 255. Alternatively, self-clinching fasteners are used. The brackets 250, 255 have a mounting face 252 that is configured to mate with the left end cap 300, right end cap 400, or center assembly 200.

FIG. 14 is a view of the radiator 100 and support bar from the engine compartment. The radiator 100 is mounted to the support bar via mounting pegs 700. The mounting peg 700 is held in bracket 250 by strap 290. The mounting peg 700 is screwed into the radiator and retained in the bracket 250. The assembly prevents torque from being transmitted through the vehicle to the radiator 100.

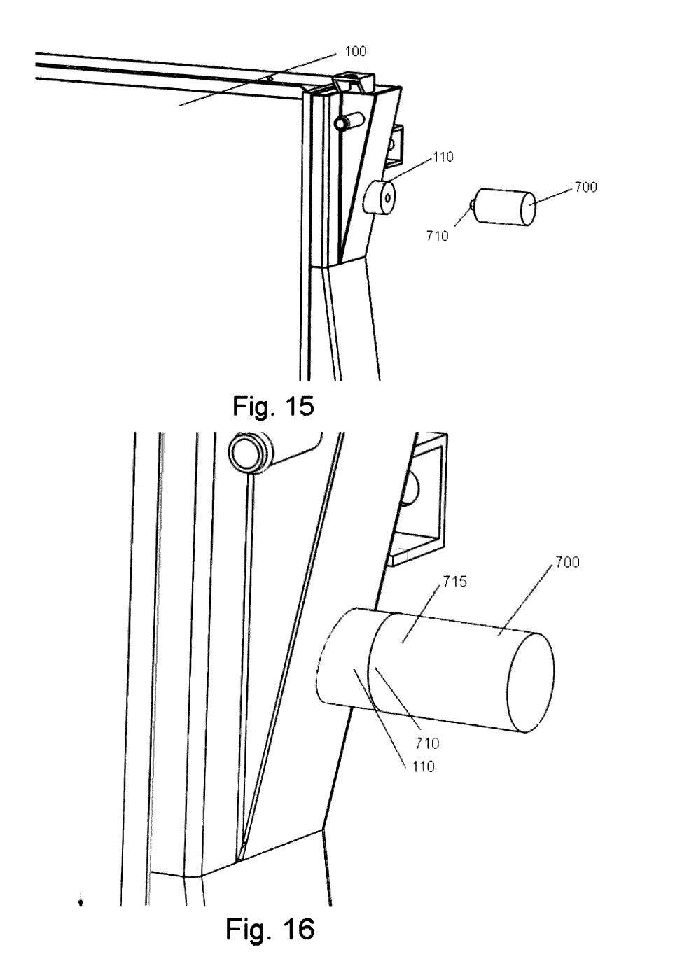

FIG. 15 is a view of the radiator 100 and the mounting peg 700 prior to the mounting peg 700 being installed on the radiator 100. The radiator 100 has a threaded mount 110 configured to accept the mounting peg 700. Alternatively, the mounting peg 700 is welded to the mount 110 or attached in another suitable manner. The mounting peg 700 has a threaded portion 710 that mates with the threaded portion of the threaded mount 110.

FIG. 16 is the mounting peg 700 attached to the radiator 100. The mounting peg 700 is a comolded metal bolt 710 and rubber portion. Typically, the mounting peg 700 is approximately 3 inches (45 mm). The bolt has a head and a threaded portion. The threaded portion is about 0.4 inches (10 mm) long. Alternatively, the threaded portion does not have a bolt head.

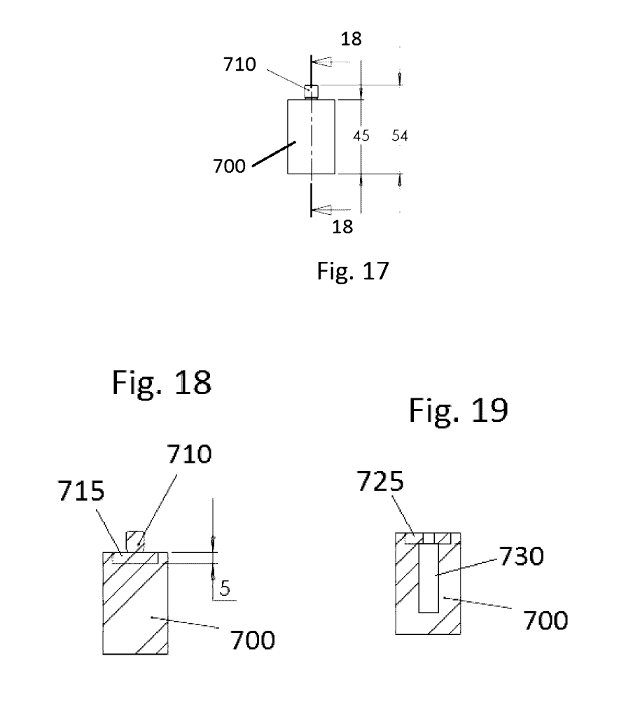

FIG. 17 is the mounting peg 700. The mounting peg 700 is a comolded metal bolt 710 and rubber portion. The mounting peg 700 is a flexible material, typically a rubber material. In one embodiment, the durometer of the rubber is 80 Shore A. The mounting peg 700 is generally circular and has a diameter of about 1.12 inches (28.5 mm). In one embodiment, the metal bolt 710 is an M8×1.25 bolt. In one embodiment, the metal bolt is grade 10.9 zinc coated steel. It should be noted that other material, finishes, and threads can be used, depending on the application. In one embodiment, in place of the threaded bolt, the mounting peg 700 has a comolded nut and a corresponding bolt is affixed to the radiator.

FIG. 18 is a cross section of the mounting peg 700. The head 715 of the comolded metal bolt 710 is shown as being about 0.2 inches (5 mm). It should be noted that the steel insert which comprises the metal bolt 715 and head 715 can have any shape that provides adequate strength. In one embodiment, the head 715 has a diameter of about 0.8 inches (20 mm).

FIG. 19 is a cross section of the mounting peg 700. The mounting peg has a nut 725 that mates with a bolt on the radiator. A clearance 730 is formed in the peg to receive the bolt on the radiator. In one embodiment, the clearance 730 is substantially the same diameter as the bolt on the radiator.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A radiator mounting assembly comprising:
a support bar comprising:
a center portion;
respective end portions welded to the center portion, wherein the end portions have respective flared ends that mate with the center portion; and
a pair of support mounts; and
at least two mounting pegs, the at least two mounting pegs having a flexible portion that mates with a respective support mount and a comolded fastening element.

2. The radiator mounting assembly of claim 1, wherein the center portion is a rectangular tube.

3. The radiator mounting assembly of claim 2, wherein the rectangular tube is substantially 2 mm thick.

4. The radiator mounting assembly of claim 1, wherein the respective end portions are cast steel.

5. The radiator mounting assembly of claim 1, wherein the respective end portions mate with the center portion with about 1 mm of clearance.

6. The radiator mounting assembly of claim 1, wherein the flexible portion is a rubber material.

7. The radiator mounting assembly of claim 6, wherein the rubber material has a Shore A hardness of 80.

8. The radiator mounting assembly of claim 1, further comprising a radiator, the radiator having receiving mounts configured to mate with the comolded fastening element of the mounting peg.

9. The radiator mounting assembly of claim 1, wherein the comolded fastening element of the mounting peg is one of a bolt and a nut.

10. A mounting peg configured to mate a support and a radiator, the mounting peg comprising:
a flexible portion configured to mate with the support; and
a comolded fastener configured to mate with a radiator.

11. The mounting peg according to claim 10, wherein the flexible portion is rubber.

12. The mounting peg according to claim 10, wherein the comolded fastener is a bolt.

13. The mounting peg according to claim 12, wherein a portion of the bolt that is embedded in the flexible portion is substantially disk shaped.

14. The mounting peg according to claim 12, wherein a threaded portion of the bolt extends from the flexible portion.

15. The mounting peg according to claim 10, wherein the comolded fastener is a nut.

16. The mounting peg according to claim 15, wherein the flexible portion defines an aperture having a longitudinal axis that corresponds with a longitudinal axis of the nut.
